(19) United States
(12) Patent Application Publication
(10) Pub. No.: US 2006/0031819 A1
(43) Pub. Date: Feb. 9, 2006

(54) Methods and apparatus for creating solutions

(75) Inventor: Robert Y. Oikawa, Redmond, WA (US)

Correspondence Address: Randy J. Pritzker;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 10/912,877

(22) Filed: Aug. 6, 2004

(51) Int. Cl. G06F 9/44

(52) U.S. Cl. 717/123

(57) ABSTRACT

Embodiments of the present-invention are directed to creating repeatable solutions so that a development team does not have to recreate an approach for developing a product, even though an approach used by a prior team for building a similar product has previously been created and would have been suitable for reuse in building the second product. In one embodiment, a method for creating a solution is provided in which a solution that defines a planned process is determined. The solution may then be documented and implementation of the solution may begin. During the implementation process, the solution may be modified and the modified solution may be documented.

### FIELD OF THE INVENTION

The present invention relates to repeatable solutions.

### DESCRIPTION OF THE RELATED ART

Development of large-scale, multi-component systems may be highly complex and may require a high degree of project management and design expertise. A team involved in the development of such a system may have a steep learning curve and may spend considerable time determining an approach to building or creating the final product before actually beginning to build or create the product. Additionally, as problems arise during the building or creation of the product, such a team may realize that the approach used was not the best approach and thus may modify the approach during the building process based on lessons learned while building the product.

A different team of developers that subsequently desires to build a similar product may face the same steep learning curve and may also spend a great deal of time determining an approach to building the product, which may be a less than optimal approach, despite the fact a workable approach to building the product may already have been created by the previous team.

For example, a first development team may develop one product in a product family and second development team may subsequently develop another product in the same product family. The second development team may have to recreate an approach for developing the second product, even though an approach used by the first team for building the first product would have been suitable for reuse in building the second product.

### SUMMARY OF THE INVENTION

One illustrative embodiment is directed to a method of creating a software system comprising acts of: determining a solution that defines a planned process for building the software system; documenting the solution; building the software system; modifying the solution during the building of the software system to generate a modified solution; and documenting the modified solution.

Another illustrative embodiment is directed to a method of creating a document comprising acts of: determining a solution that defines a planned process for creating the document; documenting the solution; creating the document; modifying the solution during the creation of the document to generate a modified solution; and documenting the modified solution.

The summary provided above is intended to provide a basic understanding of the disclosure to the reader. This summary is not an exhaustive or limiting overview of the disclosure and does not define or limit the scope of the invention in any way. The invention is limited only as defined by the claims and the equivalents thereto.

### BRIEF DESCRIPTION OF THE DRAWINGS

FIG. 1 is a flowchart illustrating a process for creating a solution, in accordance with one embodiment of the invention.

### DETAILED DESCRIPTION

One embodiment of the invention is directed to creating a solution that defines a process for building or creating a product, such as a software system or a document. As used herein, a solution is information and items (e.g., tools) that may be used to resolve a problem. The solution may include one or more solution elements. A solution element is any information or tool that aids in the resolution of the problem.

An example of a solution is a kit for building a piece of furniture. That is, for example, “ready-to-assemble” furniture kits may include all of the solution elements needed to build a piece furniture. Such a kit may include, for example, pieces of wood that are cut to desired specifications, fasteners that hold the pieces of wood together, tools such as wrenches or screwdrivers needed to assemble the pieces, paint and paintbrushes to paint the wood, and instructions that specify the steps of assembling the piece of furniture and the order in which the steps should be performed. The solution is repeatable, in that by providing an additional set of the same solution elements (e.g., wood, fasteners, tools, paint, paintbrushes and instructions) another piece of furniture may be built.

The solution may be determined, for example, by creating a plan that specifies the elements and tools needed to assemble the piece of furniture and a method for assembling those elements. The piece of furniture may then be built according to this plan. During the building process, it may be realized that additional elements or tools would aid in the building process or would create a better end product. It may also be recognized that there may be a better method for assembling the product than the method specified in the original plan. For example, it may be determined that the building process is easier when performing the steps of the method in a different order. Therefore, the solution may be modified during the building process based on the issues that arise and experiences had while attempting to build the piece of furniture according to the original plan. Thus, at the end of the assembly process, an improved solution may exist which incorporates the lessons learned from building the piece of furniture.

If a different builder decides to build a second piece of furniture of like kind to the previously built piece, the builder need not figure out the process for building the second piece of furniture. Instead, the previously determined solution may be provided to him. As a result, the time of assembly of the second piece of furniture may be much less than the time of assembly of the first piece of furniture because the second builder need not go through the time consuming process of determining what resources are needed to build the furniture and a workable method for assembling the furniture pieces (i.e., determining the best solution for building a piece of furniture).

One embodiment of the invention is directed to determining and documenting solutions for creating software systems or technical documents. Classical software development or technical authoring processes do not include as one of the items to be released the process itself that is used to produce the final product. The classical development process approach focuses on the final output (e.g., a software system or a document) and not the process used to create the final output. As a result, the process used to create the final output may be poorly documented, if at all. Reproduction of the process used to created the final output, either by the same team or another team, for the purpose of creating a similar product, may be difficult or impossible due to the fact that the process used to create the final output was not properly documented and/or the documents and specifications describing the process do not accurately reflect the actual process used to, create the output, including lessons learned during implementation of the process. As a result, many of the mistakes made and lessons learned during a first development effort may be repeated in subsequent development efforts.

To improve upon this, in one embodiment of the invention, a solution for building a software system or creating a technical document is determined and documented. The solution may be implemented (or attempted to be implemented) to generate the product (i.e., the software system or technical document). During the implementation process (i.e., the building of the software system or the writing of the document), a better solution may be recognized or problems may arise that highlight deficiencies in the solution. Thus, the solution may be modified (e.g., based on lessons learned) during the implementation process and the modified solution may be documented.

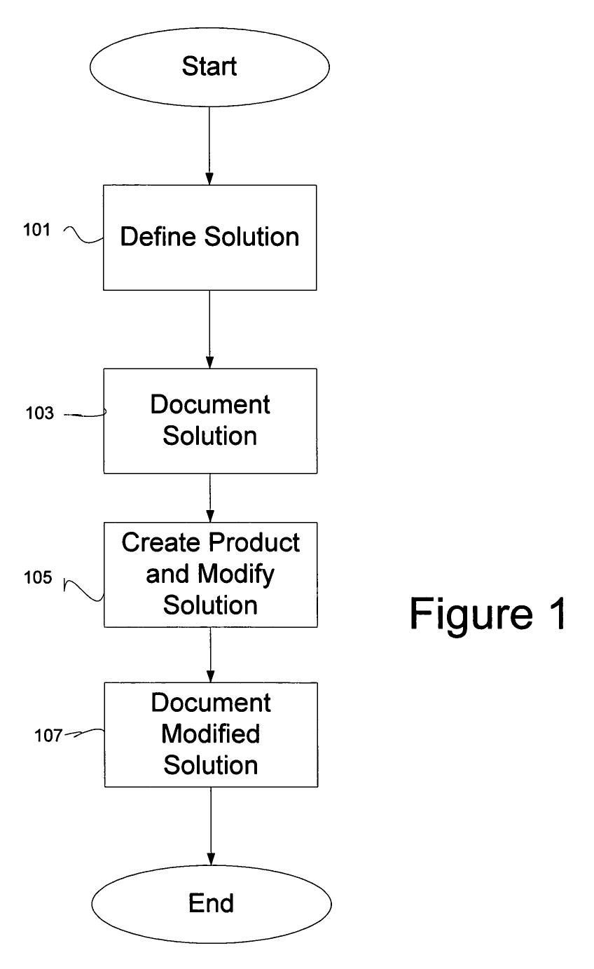

For example, FIG. 1 shows a process that may be used to create a solution. Such a solution may be a solution, for example, for creating a security hardening guide for a software product. The security hardening guide is a document (e.g., in book form) that explains how to configure the software product in a secure fashion. For example, a security hardening guide may be created for a particular operating system that explains how to configure the operating system securely. As shown at act 101 of FIG. 1, a solution for the security hardening guide may be defined. This may include, for example, defining a process for writing the document. More specifically, the solution may include, for example, determining how information in the book should be organized, determining an easy-to-understand format for the book, determining in what order and at what level of detail to present information, determining the steps that need to be taken in order to collect the information and write the document, and/or any other suitable information that may aid in the authoring process. Defining the solution may also include determining the constraint or constraints of the solution. That is, the scope of projects to which the solution may be applied may be determined. For example, it may be determined that the solution defined for creating the operating system security hardening guide may only be used to create security hardening guides for software products or it may be determined that the solution may only be used to create security hardening guides for operating systems. Thus, if it is attempted to use the solution to create, for example, a “how-to” book on gardening, the solution is not guaranteed to work for that particular problem.

The process may then continue to act 103, wherein the solution may be documented. Documenting the solution for the security hardening guide may include, for example, creating one or more solution elements that may be employed when re-using the solution. For example, an outline may be created that shows the planned organization for the document, templates may be created that demonstrate the format of the document and one or more flowcharts may be defined that illustrate the steps that should be taken to collect the appropriate information and to author the document. The flowchart(s) may also show the order in which these steps should be performed. Any other suitable documents may also be created.

The documents may also indicate portions of the solution that are generic to any final product and portions of the solution that are specific to a particular final product. For example, a document template for a certain section of a security hardening guide may include a heading that can be used in any security hardening guide, but the text under that heading should be specific to a particular software product. Thus, the template may leave the portion of the solution that is specific to the particular software product blank and indicated that it is to be filled in with specifics for particular product. For example, a solution element template may include the heading “Operating System Installation Checklist.” Under the heading, space may be left for inserting an operating system installation checklist that is specific to a particular operating system. The template (or another document) may provide guidelines for filling the blank space. For example, a guideline may be provided that the checklist should have more than ten items or the checklist should specify hardware requirements of the system on which the operating system is to be installed. In one embodiment, these guidelines may be provided in the form of prompting questions (e.g., “Does the checklist have more than 10 items?”). However, the guidelines may be provided in any suitable form as the invention is not limited in this respect.

In the flowchart of FIG. 1, the act of documenting the solution is shown as being performed after the act of defining the solution. However, it should be appreciated that the invention is not limited in this respect. That is, it is not required that the solution be completely defined before any of it is documented. For example, the act of creating the solution and documenting the solution may be performed at least partially in parallel. That is, for example, portions of the solution may be documented as they are defined.

In this respect, it should also be understood the act of defining the solution may be performed during the implementation process, as the invention is not limited to defining a solution before beginning the implementation process. For example, the solution may be defined in a “learn-as-you-go” process in which the solution is defined, documented, and modified while the end product is being created. In this respect, it should be appreciated that the phrase “modifying a solution” as used herein means changing, adding to, or removing from a solution.

The process continues to act 105, where the product (i.e., the document) may be created and the solution may be modified during the process of creating the product. For example, writing of the document may begin and the solution may be modified based on lessons learned during the writing of the document. For example, it may be recognized that an additional section should be included in a security hardening guide on choosing favorable passwords (i.e., choosing passwords that may not be easily guessed or deciphered). Thus, the solution may be modified to include a section on choosing favorable passwords. As another example, it may be recognized that there is a more advantageous order of steps for writing the document than the originally planned order or the order in which the steps were actually performed. The solution may be modified in any suitable way during the process of creating the end product to incorporate any improvements that may be recognized during the creation process, as the invention is not limited in this respect.

The process then continues to act 107, wherein the modified solution may be documented. In the flowchart of FIG. 1, the act of documenting the modified solution is shown as being performed after the act of creating the product and modifying the solution. However, the invention is not limited in this respect as the act of documenting the modified solution may be performed at least partially in parallel with the act of modifying the solution. Further, it should be appreciated that the solution may be modified multiple times during the creation process and each of these modifications may be documented.

In one embodiment of the invention, documenting the modified solution may be accomplished by creating a second set of solution elements separate from the original set of solution elements. The second set of solution elements may include the modifications to the original set of solution elements. Accordingly, when the solution is modified, the previous solution is still maintained and is not overwritten or discarded. Thus, if it is later determined during the creation process that the modified solution is deficient, it is possible to revert back, at least in part, to the original solution.

If the solution is modified multiple times during the building process, a set of solution elements may be stored for each modified solution. Thus, any of these versions of the solution may be reverted back to if the most current solution is determined to be deficient. Further, by storing all of the solution elements together for a particular solution, it is easier for a subsequent team that is creating a similar product to locate and use the final version of the solution elements. After the modified solution is documented, the process ends.

In one embodiment of the invention, after the end solution (i.e., after all modifications) is documented, the solution may be verified by testing the solution elements to ensure that the end solution will yield a workable end product. For example, the process of creating a product may be attempted using the end solution. If the implementation of the end solution does not work, then the solution may be modified to correct any deficiencies and the modifications may be documented.

The end solution may be re-used to create a similar product. For example, the end solution used to create the security hardening guide for a particular operating system may be used to create a security hardening guide for a different operating system. Because the team creating the second security hardening guide may use the solution elements from the previously created solution, this team need not spend time determining things like all of the steps needed, the best organization of, the best format of, the order in which steps should be performed, etc. As a result, the time taken to create the end product may be reduced.

The above example described the creation of a solution for a security hardening guide. However, it should be appreciated that the invention is not limited to the creation of solutions of security hardening guides. A solution for producing any suitable document may be created using the method depicted in the flowchart of FIG. 1. Further, the method depicted in the flowchart of FIG. 1 may be used to create solutions for producing software systems.

For example, a solution for a software system may include solution elements, such as requirements documents, design specifications, functional specifications, project plans, flowcharts of process steps, project schedules, and/or any other documents that may aid in the development process. As in the example described above, portions of such documents may be generic to many different software systems or types of software systems while other portions may be specific to a particular software system. Thus, the portions that are specific to a particular software system may be left blank to be filled in for a particular software system. The portions that are to be filled in for a particular software system may provide guidelines or criteria for filling in that portion. The solution elements may also include tools, such as compilers, test programs, software application programs used in development, code skeletons (e.g., code templates), and/or any other suitable tool that may aid in the building of the software system. The solution for the software system may be determined, documented, and modified, in a similar manner as described above in connection with FIG. 1.

In one embodiment of the invention, a software application program may be provided that aids in the creation of a solution. For example, the software application program may store solution elements as separate versions, may allow for editing and modification of the solution elements, may provide reminders during the creation process to document any modifications made to the solution elements, and/or may perform any other suitable task that aids in the creation of a solution.

The above-described embodiments of the present invention can be implemented in any of numerous ways. For example, the embodiments may be implemented using hardware, software or a combination thereof. In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of creating a software system comprising acts of:
determining a solution that defines a planned process for building the software system;
documenting the solution;
building the software system;
modifying the solution during the building of the software system to generate a modified solution; and
documenting the modified solution.

2. The method of claim 1, further comprising an act of:
verifying that the modified solution defines a process that yields the software system.

3. The method of claim 1, wherein the software system is a first software system and the method further comprises an act of:
building a second software system based on the modified solution.

4. The method of claim 1, wherein the act of determining the solution further comprises an act of specifying at least one constraint that indicates the scope of problems to which the solution may be applied.

5. The method of claim 1, wherein the act of determining the solution further comprises an act of defining at least one portion of the solution that is applicable to building other software systems and defining at least one portion of the solution that is specific to the software system.

6. The method of claim 5, wherein the software system is a first software system and wherein the act of defining at least one portion of the solution that is specific to the first software system further comprises an act of indicating in the solution that the at least one portion of the solution that is specific to the first software system is to be replaced when using the solution to build a second software system that is different from the first software system.

7. The method of claim 6, wherein the act of indicating that the at least one portion of the solution that is specific to the software system is to be replaced when using the solution to build the second software system further comprises an act of:
providing at least one guideline for replacing the at least one portion of the solution that is specific to the software system with a portion of the solution that is specific to the second software system.

8. The method of claim 7, wherein the at least one guideline is provided in the form of a question.

9. The method of claim 1, wherein the act of documenting the solution comprises an act of creating a plurality of solution elements.

10. The method of claim 9, wherein the plurality of solution elements is a first plurality of solution elements and wherein the act of documenting the modified solution further comprises acts of:
copying the first plurality of solution elements to generate a second plurality of solution elements; and
modifying at least one of the second plurality of solution elements.

11. The method of claim 10, further comprising an act of:
storing the second plurality of solution elements separately from the first plurality of solution elements.

12. The method of claim 1, wherein the act of modifying the solution further comprises an act of modifying the solution based, at least in part, on recognition of a deficiency in the planned process.

13. The method of claim 1, wherein the act of modifying the solution further comprises an act of modifying the solution based, at least in part, on an issue arising during the building of the software system.

14. The method of claim 1, wherein the acts of determining the solution and building the software system are performed at least partially in parallel.

15. The method of claim 1, wherein the act of determining the solution is performed before the act of building the software system.

16. A method of creating a document comprising acts of:
determining a solution that defines a planned process for creating the document;
documenting the solution;
creating the document;
modifying the solution during the creation of the document to generate a modified solution; and
documenting the modified solution.

17. The method of claim 16, further comprising an act of:
verifying that the modified solution defines a process that yields the document.

18. The method of claim 16, wherein the document is a first document and the method further comprises an act of:
creating a second document based on the modified solution.

19. The method of claim 16, wherein the act of determining the solution further comprises an act of specifying at least one constraint that indicates the scope of problems to which the solution may be applied.

20. The method of claim 16, wherein the act of determining the solution further comprises an act of defining at least one portion of the solution that is applicable to creating other documents and defining at least one portion of the solution that is specific to the document.

21. The method of claim 20, wherein the document is a first document and wherein the act of defining at least one portion of the solution that is specific to the first document further comprises an act of indicating in the solution that the at least one portion of the solution that is specific to the first document is to be replaced when using the solution to create a second document that is different from the first document.

22. The method of claim 21, wherein the act of indicating that the at least one portion of the solution that is specific to the document is to be replaced when using the solution to create the second document further comprises an act of:
providing at least one guideline for replacing the at least one portion of the solution that is specific to the document with a portion of the solution that is specific to the second document.

23. The method of claim 22, wherein the at least one guideline is provided in the form of a question.

24. The method of claim 16, wherein the act of documenting the solution comprises an act of creating a plurality of solution elements.

25. The method of claim 24, wherein the plurality of solution elements is a first plurality of solution elements and wherein the act of documenting the modified solution further comprises acts of:
copying the first plurality of solution elements to generate a second plurality of solution elements; and
modifying at least one of the second plurality of solution elements.

26. The method of claim 25, further comprising an act of:
storing the second plurality of solution elements separately from the first plurality of solution elements.

27. The method of claim 16, wherein the act of modifying the solution further comprises an act of modifying the solution based, at least in part, on recognition of a deficiency in the planned process.

28. The method of claim 16, wherein the act of modifying the solution further comprises an act of modifying the solution based, at least in part, on an issue arising during the creation of the document.

29. The method of claim 16, wherein the acts of determining the solution and creating the document are performed at least partially in parallel.

30. The method of claim 16, wherein the act of determining the solution is performed before the act of creating the document.

31. At least one computer-readable medium encoded with instructions that, when executed on a computer system, perform a method comprising acts of:
accepting as input a first solution;
allowing a user to modify the solution to generate a second solution; and
storing the second solution separately from the first solution.
